(19) United States
(12) Patent Application Publication
(10) Pub. No.: US 2026/0109365 A1
(43) Pub. Date: Apr. 23, 2026

(54) REVERSE CONTROL SYSTEM FOR SADDLE RIDING UTILITY VEHICLE

(71) Applicant: Honda Motor Co., Ltd., Tokyo (JP)

(72) Inventors: Jianhua Zhen, Marysville, OH (US); Seth A. Ritchie, Marysville, OH (US); Kyle Streetz, Hilliard, OH (US); Uwe Wolf, Dublin, OH (US)

(21) Appl. No.: 18/920,575

(22) Filed: Oct. 18, 2024

(51) Int. Cl. B60W 50/08; B60W 30/18

(52) U.S. Cl. CPC B60W 50/082; B60W 30/18036; B60W 2300/362; B60W 2720/10

(57) ABSTRACT

A reverse control system for a saddle riding utility vehicle includes a first switch configured to be displaced from a free position to a depressed position to activate a reversing of the saddle riding utility vehicle. The reverse control system also includes a second switch adapted to be actuated by a user to activate the reversing of the saddle riding utility vehicle. Moreover, a controller is communicatively coupled to the first switch, the second switch, and the drive system. The controller is configured to control the drive system to activate the reversing of the saddle riding utility vehicle in response to the actuation of the second switch, with the first switch being arranged at the depressed position, before elapse of a predefined time duration from the displacement of the first switch to the depressed position from the free position.

### BACKGROUND

The disclosed subject matter relates to saddle riding utility vehicles. More particularly, the disclosed subject matter relates to a reverse control system for a saddle riding utility vehicle.

Saddle riding vehicles generally do not include a reversing system for driving the vehicle in reverse. Instead, the rider is expected to manually move the motorcycle when it is desired to move the motorcycle backward. However, some saddle riding vehicles are large and heavy, and are difficult to move in the reverse direction manually.

### SUMMARY

In accordance with one embodiment of the present disclosure, a reverse control system for a saddle riding utility vehicle is disclosed. The saddle riding utility vehicle includes a drive system arranged to move the saddle riding utility vehicle in a forward direction and a reverse direction opposite to the forward direction. The reverse control system includes a first switch configured to be displaced from a free position to a depressed position to activate a reversing of the saddle riding utility vehicle. The reverse control system also includes a second switch adapted to be actuated by a user to activate the reversing of the saddle riding utility vehicle. Moreover, the reverse control system includes a controller communicatively coupled to the first switch, the second switch, and the drive system. The controller is configured to control the drive system to activate the reversing of the saddle riding utility vehicle in response to the actuation of the second switch, with the first switch being arranged at the depressed position, before elapse of a predefined time duration from the displacement of the first switch to the depressed position from the free position.

In accordance with another embodiment of the present disclosure, a saddle riding utility vehicle is disclosed. The saddle riding utility vehicle includes a plurality of wheels including at least one drive wheel, and a drive system operatively coupled to the at least one drive wheel to move the saddle riding utility vehicle in a forward direction and a reverse direction. The saddle riding utility vehicle further includes a first switch configured to be displaced from a free position to a depressed position to activate a reversing of the vehicle, and a second switch adapted to be actuated by a user to activate the reversing of the saddle riding utility vehicle. Moreover, the saddle riding utility vehicle includes a controller communicatively coupled to the first switch, the second switch, and the drive system. The controller is configured to control the drive system to activate the reversing of the saddle riding utility vehicle in response to the actuation of the second switch, with the first switch being arranged at the depressed position, before elapse of a predefined time duration from the displacement of the first switch to the depressed position from the free position.

In accordance with yet a further embodiment of the present disclosure a method for controlling a saddle riding utility vehicle is disclosed. The saddle riding utility vehicle has a drive system to move the saddle riding utility vehicle in a forward direction and a reverse direction. The method includes determining, by a controller, a displacement of a first switch to a depressed position from a free position. The method further includes determining, by the controller, an actuation of the second switch when the first switch is arranged at the depressed position. Moreover, the method includes controlling, by the controller, the drive system to activate a reversing of the saddle riding utility vehicle in response to the actuation of the second switch before an elapse of a predetermined duration from the displacement of the first switch to the depressed position.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective view of a saddle riding utility vehicle, in accordance with one embodiment of the present disclosure;

FIG. 2 illustrates a perspective view of a switch assembly of the saddle riding utility vehicle of FIG. 1, in accordance with one embodiment of the present disclosure; and

FIG. 3 is a block diagram of the vehicle of FIG. 1 and schematically depicts various components of the vehicle, in accordance with one embodiment of the present disclosure.

### DETAILED DESCRIPTION OF EXEMPLARY EMBODIMENTS

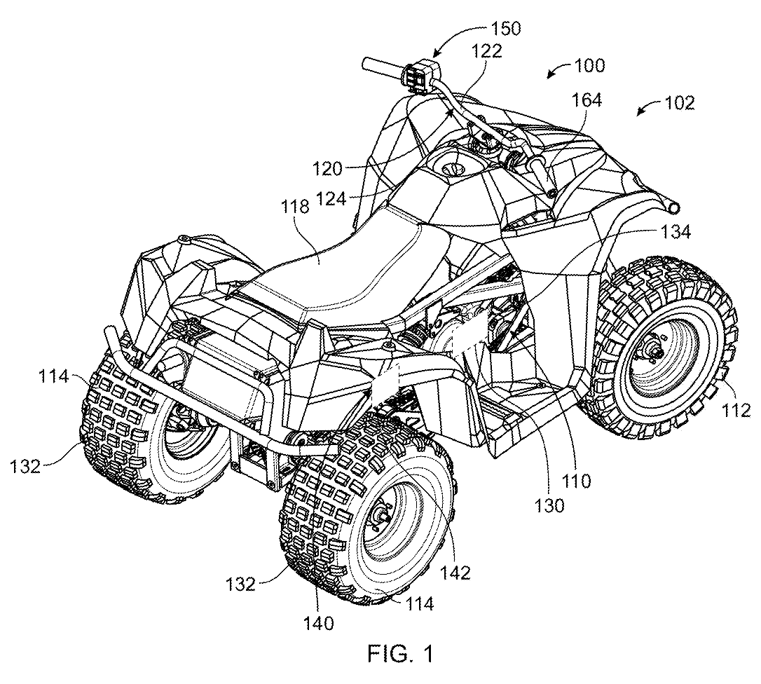

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-3, wherein like numbers indicate the same or corresponding elements throughout the views.

FIG. 1 illustrates a perspective view of a vehicle, indicated generally as 100, in accordance with one embodiment of the present disclosure. As shown, vehicle 100 is a saddle riding utility vehicle 102. However, it may be envisioned that the vehicle may be a scooter, motorcycle, other type of all-terrain vehicle, or any other similar vehicle known in the art. As depicted in FIG. 1, the vehicle 100 includes a frame 110, a plurality of wheels, for example, a pair of front wheels 112 and a pair of rear wheels 114, coupled to the frame 110 and adapted to rotate to enable a movement of the vehicle 100 over a path, and a seat 118 supported on the frame 110 to facilitate a seating of at least one person on the vehicle 100. Further, the vehicle 100 includes a handlebar assembly 120 having a handlebar 122, a steering tube 124, and a pair of suspension forks (not shown) extending downwardly from the steering tube 124 and coupled to the front wheel 112. The steering tube 124 is rotatably coupled to the frame 110, and the handlebar 122 is attached to the steering tube 124 to enable a rotation of the steering tube 124 by a rider to facilitate the steering of the vehicle 100.

Further, the vehicle 100 includes a power source 130 providing motive power to the vehicle 100 to rotate at least one drive wheel 132 of the vehicle 100. In the illustrated embodiment, the at least one drive wheel 132 includes the rear wheels 114 of the vehicle 100, however, the at least one drive wheel 132 may include the front wheels 112 or both the front wheels 112 and the rear wheels 114 of the vehicle 100. Moreover, in the illustrated embodiment, the power source 130 includes at least one electrical energy storage unit 134 to store electrical power and provide electrical power to electrical and electronic components of the vehicle 100. The at least one electrical energy storage unit 134 may include one or more of battery, ultracapacitor, supercapacitor, inductors, or a combination thereof. Also, the electrical energy storage unit 134 may be a rechargeable unit configured to be recharged by using a suitable external power source. Although the electrical energy storage unit 134 is contemplated as the power source 130, it may be appreciated that, in some embodiments, the power source 130 may be an internal combustion engine.

Further, the vehicle 100 includes a drive system 140 operatively connected to the power source 130 and configured to rotate the at least one drive wheel 132, for example, rear wheels 114. In the embodiment, the drive system 140 includes at least one electric traction motor 142 adapted to receive electrical energy from the at least one electrical energy storage unit 134 and rotates the rear wheels 114. In the embodiment, the at least one electric traction motor 142 is a bi-directional motor configured to rotate in a first direction and a second direction opposite to the first direction. Accordingly, the at least one electric traction motor rotates the rear wheels 114 in the first direction to move the vehicle 100 in a forward direction and in the second direction to move the vehicle 100 in the reverse direction, i.e., reversing the vehicle 100.

In some embodiments, the at least one electric traction motor 142 may be a unidirectional motor and is configured to rotate in the first direction. In such a scenario, to move the vehicle 100 in the reverse direction, the vehicle 100 may include a transmission arranged between the at least one electric traction motor 142 and the rear wheels 114 and having at least one forward gear and a reverse gear. In some embodiment, the transmission may be a manual transmission, an automatic transmission, or a semi-automatic transmission.

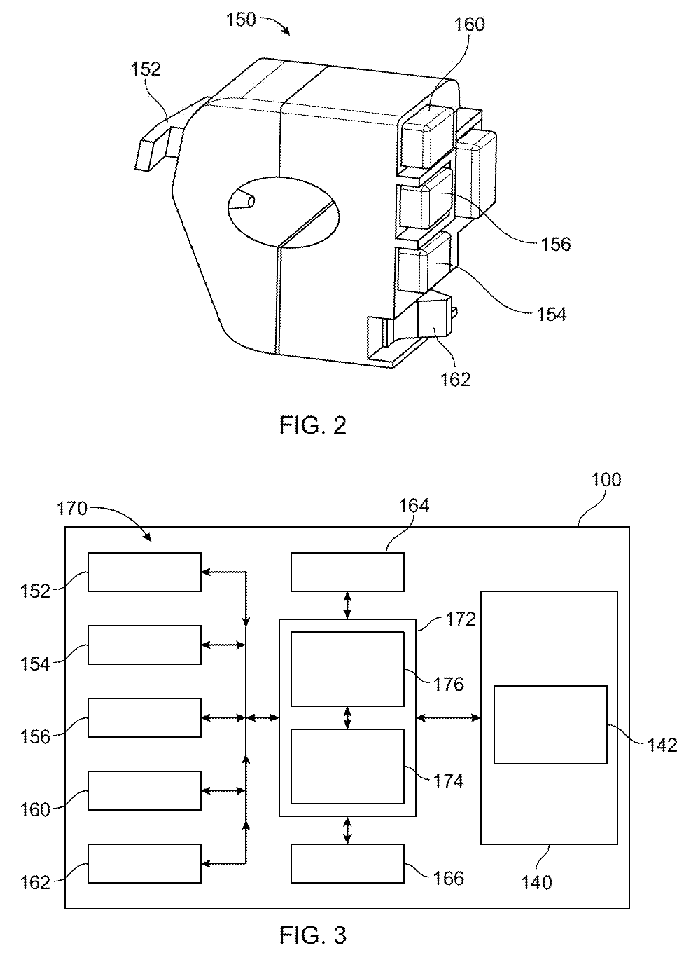

To enable a user to control the movement of the vehicle 100 and therefore control the drive system 140, the vehicle 100 includes a switch assembly 150 that may be mounted to the handlebar 122 and arranged proximate to one of the handle grips of the handlebar 122. As shown in FIG. 2, the switch assembly 150 includes a plurality of switches adapted to be manipulated by a driver of the vehicle 100 to enable the driver of the vehicle 100 to control the drive system 140 of the vehicle 100. As shown, the switch assembly 150 includes a first switch 152, i.e. a reverse inhibitor switch 152, to activate/permit and deactivate/inhibit the reversing of the vehicle 100, and a second switch 154, also referred to as a reverse selector switch, to control the drive system 140 to activate/permit the reversing of the vehicle 100.

Moreover, the switch assembly 150 includes a third switch 156, also referred to as a neutral switch, to disengage the at least one electric traction motor 142 from the rear wheels 114 or prevents the rotation of the at least one electric traction motor 142 and/or the rear wheels 114 even upon actuation of a throttle of the vehicle 100. In some embodiments, the drive system 140 may include a clutch (not shown) arranged between the at least one electric traction motor 142 and the rear wheels 114 to engage and the disengage the at least one electric traction motor 142 and the rear wheels 114. In such a case, the clutch is operated, upon actuation of the third switch 156, to disengage the at least one electric traction motor 142 and the rear wheels 114.

The switch assembly 150 also includes a fourth switch 160 to engage or disengage the direct drive to move the vehicle 100 in the forward direction i.e., to activate the rotation of the at least one electric traction motor 142 in the first direction. Furthermore, the switch assembly 150 includes a fifth switch 162, also referred to as start-stop switch 162, to start and stop at least one electric traction motor 142. Additionally, the vehicle 100 includes a throttle lever 164, shown in FIGS. 1 and 3, to control the speed of the travel of the vehicle 100 and move the vehicle in a desired direction. Also, the vehicle 100 includes a speed sensor 166, shown in FIG. 3, to detect/monitor a speed of the vehicle 100 in the forward direction and/or the reverse direction.

As shown, the first switch 152 is adapted to be displaced/pressed between a free position and a depressed position and is biased to the free position. In the illustrated embodiment, the first switch 152 is a spring biased switch in which a spring biases the first switch 152 to the free position. The driver displaces/presses/moves the first switch 152 to the depressed position to activate/permit the reversing of the vehicle 100. It is to be noted that the reversing of the vehicle 100 is inhibited when the first switch 152 is at the free position. The vehicle 100 may include a suitable mechanism, known in the art, that disables the rotation of the at least one electric traction motor 142 in the second direction when the first switch 152 is arranged at the free position, inhibiting the reversing of the vehicle 100. In some embodiments, for example, a signal to rotate the at least one electric traction motor 142 in the second direction is blocked to the at least one electric traction motor 142 when the first switch 152 is arranged at the free position. Accordingly, the first switch 152 is a fail-safe switch that needs to be manipulated by the driver to activate the reversing of the vehicle 100 and prevents any undesired reversing of the vehicle 100.

Moreover, to control/activate the reversing of the vehicle 100, referring to FIG. 3, the vehicle 100 includes a reverse control system 170 that includes the first switch 152, the second switch 154, and a controller 172 communicatively coupled to the first switch 152 and the second switch 154. The controller 172 may also be communicatively coupled to the third switch 156, the fourth switch 160, the fifth switch 162, the throttle lever 164, the speed sensor 166, the drive system 140, and any other electrical and electronic system of the vehicle 100. The controller 172 is adapted to control the drive system 140 based on input received from the switches 152, 154, 156, 160, 162, the throttle lever 164, the speed sensor 166. The controller 172 may control the at least one electric traction motor 142 based on predefined instructions stored inside a memory 174 of the controller 172, and controls the operation of the vehicle 100 and one or more components, systems, and sub-systems, for example, the drive system 140, of the vehicle 100. In an embodiment, the controller 172 is an electronic control module (ECM) of the vehicle 100.

The controller 172 includes a processor 176 and the memory 174 to respectively process and store the data received from the at least one sensor and other electrical and electronic component of the vehicle 100. In some embodiments, the instructions to process the data and/or control the various components of the vehicle 100, for example, the switches 152, 154, 156, 160, 162, the throttle lever 164, the speed sensor 166, the at least one electric traction motor 142, any other electrical or electronic component of the vehicle 100 is stored inside the memory 174 of the controller 172.

The memory 174 may be integrated into the controller 172, but those skilled in the art will understand that the memory 174 may be separate from the controller 172 but onboard the vehicle 100, and/or remote from the controller 172 and the vehicle 100, while still being associated with and accessible by the controller 172 to store information in and retrieve information from the memory 174 as necessary during the operation of the vehicle 100 i.e., reverse control system 170, the drive system 140, the at least one electric traction motor 142, etc. Although the processor 176 is contemplated, it is also possible and contemplated to use other electronic components such as a microcontroller, an application specific integrated circuit (ASIC) chip, or any other integrated circuit device. The processor 176 is configured to execute specified instructions, which controls and monitors various functions associated with the drive system 140, the at least one electric traction motor 142, and any other system or component of the vehicle 100, etc.

The processor 176 is configured actuate/operate/control the drive system 140 to activate the reversing the vehicle 100 i.e., to enable the movement of the vehicle 100 in the reverse direction upon determination of the manipulation of the first switch 152 and the second switch 154 in a predefined sequence and as per the predefined criteria. The predefined sequence includes the pressing of the second switch 154 after moving/pressing/displacing the first switch 152 to the depressed position while holding the first switch at the depressed position. The predefined criteria include pressing of the second switch 154 within a predetermined duration i.e., before an elapse of the predetermined duration, of displacing the first switch 152 to the depressed position from the free position. Accordingly, the processor 176 is configured to operate/actuate/control the drive system 140 to activate reversing the vehicle in response to displacement of the first switch 152 to the depressed position and then pressing of the second switch 154, while holding the first switch 152 to the depressed position, before the elapse of the predetermined duration from the displacement of the first switch 152 to the depressed position.

Also, before activating the reversing of the vehicle 100, the processor 176 may be configured to determine a speed of the vehicle 100, based on input from the speed sensor 166, when the first switch 152 is moved/displaced/pressed to the depressed position. The processor 176 is configured to activate the drive system 140 for reversing the vehicle 100 if the speed of the vehicle 100 in the forward direction is below a predefined threshold value or the vehicle 100 is at rest when the first switch 152 is displaced to the depressed position. In some embodiments, the predefined threshold value is one mile/hour.

Moreover, the processor 176 may be configured to operate/actuate the drive system 140 and initiates the movement of the vehicle 100 in the reverse direction upon actuation of the throttle lever 164, and controls the speed of the vehicle 100 in the reverse direction based on the displacement of the throttle lever 164 from its free position. It may be appreciated that the processor 176 may set a maximum speed limit to the movement of the vehicle 100 in the reverse direction. In some embodiments, the processor 176 may move the vehicle 100 in the reverse direction at a preset speed without actuation of the throttle lever 164. Accordingly, the controller 172 i.e., processor 176 is configured to move the vehicle 100 in the reverse direction till the first switch 152 is arranged/held at the depressed upon enabling the movement of the vehicle 100 in the reverse direction. Accordingly, the processor 176 is configured to operate/control the drive system 140 to deactivate the movement of the at least one electric traction motor 142 in the second direction, and therefore stops the movement of the vehicle 100 in the reverse direction upon detection of release of the first switch 152 from the depressed position to the free position. In some embodiments, the controller 172 i.e., processor 176 may be configured to control the drive system 140 to disable the reversing of the vehicle 100 and stops moving the vehicle 100 upon detection of pressing/actuation of the neutral switch 156.

A method for controlling the vehicle 100 and moving the vehicle 100 in the reverse direction is now described. For moving the vehicle 100 in the reverse direction, the driver of the vehicle 100, at first, activates the reversing of the vehicle 100. For activating/enabling the reversing of the vehicle 100, the driver may press the first switch 152 to the depressed position and then presses the second switch 154, while holding the first switch 152 to the depressed position. It may be noted that the driver moves/displaces/presses the fifth switch 162 to a start position before moving the first switch 152 to the depressed position to enable a flow of electric current to the at least one electric traction motor 142. The processor 176 determines the actuation of the second switch 154 while holding the first switch 152 and determines if the second switch 154 is pressed/actuated/moved before elapse of the predetermined duration from the displacement of the first switch 152 to the depressed position.

The processor 176 activates the reversing of the of vehicle 100 i.e., enables/prepares/activates/permits the rotation of the at least one electric traction motor 142 in the second direction in response to the determination of the second switch 154 being pressed/actuated while holding the first switch 152 to the depressed position and before elapse of the predetermined duration from the displacement of the first switch 152 to the depressed position. In some embodiments, the predetermined duration is between one second and 10 seconds. In some embodiments, the predetermined duration is 1 second. In some embodiments, the processor 176 also checks the forward speed of the vehicle 100 when the first switch 152 is moved to the depressed position and activates the reversing of vehicle 100 when the forward speed of the vehicle 100 is below the predefined threshold value or the vehicle 100 is at rest.

Upon activating the reversing of the vehicle 100, the controller 172 may check the displacement/actuation of the throttle lever 164 before starting the movement of the vehicle 100 in the reverse direction, and moves the vehicle 100 in the reverse direction upon displacement/actuation of the throttle lever 164 from the default position. In such a scenario, the speed of the vehicle 100 in the reverse direction may correspond to the displacement of the throttle lever 164 from the default position. Also, the processor 176 may set a maximum speed limit for the movement of the vehicle 100 in the reverse direction. In some embodiments, the processor 176 may control the drive system 140 i.e., operate the at least one electric traction motor 142 to move the vehicle 100 in the reverse direction at a preset speed without any intervention from the driver i.e., without actuation i.e., displacement of the throttle lever 164 from a free position i.e. default position of the throttle lever 164. In this manner, by having two inputs from the driver, the reverse control system 170 provides a fail-safe mechanism to prevent any undesired reversing of the vehicle 100. Although, the vehicle 100 is contemplated as the electric saddle riding utility vehicle, it may be envisioned that the vehicle may be internal combustion powered vehicle having an internal combustion as a power source and a transmission having one or more forward gears and a reverse gear to control the movement of the vehicle in the forward direction and the reverse direction. In such a case, the reverse gear is engaged upon activating the reversing of the vehicle.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended the scope of the disclosure be defined by the claims appended hereto.

What is claimed is:

1. A reverse control system for a saddle riding utility vehicle including a drive system arranged to move the saddle riding utility vehicle in a forward direction and a reverse direction opposite to the forward direction, the reverse control system comprising:
a first switch configured to be displaced from a free position to a depressed position to activate a reversing of the vehicle;
a second switch adapted to be actuated by a user to activate the reversing of the vehicle; and
a controller communicatively coupled to the first switch, the second switch, and the drive system, the controller is configured to control the drive system to activate the reversing of the saddle riding utility vehicle in response to the actuation of the second switch, with the first switch being arranged at the depressed position, before elapse of a predefined time duration from the displacement of the first switch to the depressed position from the free position.

2. The reverse control system of claim 1, wherein the controller is configured to activate the reversing of the saddle riding utility vehicle when the saddle riding utility vehicle is at rest when the first switch is displaced to the depressed position.

3. The reverse control system of claim 1, wherein the controller is configured to activate the reversing of the saddle riding utility vehicle when a speed of the saddle riding utility vehicle in the forward direction is below a predefined threshold value when the first switch is displaced to the depressed position.

4. The reverse control system of claim 3, wherein the predefined threshold value is 1 miles/hour.

5. The reverse control system of claim 1, wherein in the free position of the first switch, the reversing of the saddle riding utility vehicle is inhibited.

6. The reverse control system of claim 1, wherein the drive system includes at least one electric traction motor operatively coupled to at least one drive wheel of the saddle riding utility vehicle to move the saddle riding vehicle in the forward direction and the reverse direction, wherein the at least one electric traction motor is a bi-directional motor.

7. A saddle riding utility vehicle, comprising:
a plurality of wheels including at least one drive wheel;
a drive system operatively coupled to the at least one drive wheel to move the saddle riding utility vehicle in a forward direction and a reverse direction;
a first switch configured to be displaced from a free position to a depressed position to activate a reversing of the vehicle;
a second switch adapted to be actuated by a user to activate the reversing of the saddle riding utility vehicle; and
a controller communicatively coupled to the first switch, the second switch, and the drive system, the controller is configured to control the drive system to activate the reversing of the saddle riding utility vehicle in response to the actuation of the second switch, with the first switch being arranged at the depressed position, before elapse of a predefined time duration from the displacement of the first switch to the depressed position from the free position.

8. The saddle riding utility vehicle of claim 7, wherein the controller is configured to activate the reversing of the saddle riding utility vehicle when the saddle riding utility vehicle is at rest when the first switch is displaced to the depressed position.

9. The saddle riding utility vehicle of claim 7, wherein the controller is configured to activate the reversing of the saddle riding utility vehicle when a speed of the saddle riding utility vehicle in the forward direction is below a predefined threshold value when the first switch is displaced to the depressed position.

10. The saddle riding utility vehicle of claim 9, wherein the predefined threshold value is 1 miles/hour.

11. The saddle riding utility vehicle of claim 7, wherein at the free position of the first switch, the reversing of the saddle riding utility vehicle is inhibited.

12. The saddle riding utility vehicle of claim 7, wherein the drive system includes at least one electric traction motor operatively coupled to at least one drive wheel of the saddle riding utility vehicle to move the saddle riding vehicle, wherein the at least one electric traction motor is a bi-directional motor and rotates in a first direction and a second direction opposite to the first direction to move the saddle riding utility vehicle in the forward direction and the reverse direction, respectively.

13. The saddle riding utility vehicle of claim 12, wherein the controller enables the rotation of the at least one electric traction motor in the second direction in response to the actuation of the second switch, with the first switch being arranged at the depressed position, before elapse of a predefined time duration from the displacement of the first switch to the depressed position from the free position.

14. The saddle riding utility vehicle of claim 7, further including a throttle lever and the controller moves the saddle riding utility vehicle in the reverse direction upon actuation of the throttle lever upon activating the reversing of the saddle riding utility vehicle.

15. A method for controlling a saddle riding utility vehicle having a drive system to move the saddle riding utility vehicle in a forward direction and a reverse direction, the method comprises:
determining, by a controller, a displacement of a first switch to a depressed position from a free position;
determining, by the controller, an actuation of the second switch when the first switch is arranged at the depressed position; and
controlling, by the controller, the drive system to activate a reversing of the saddle riding utility vehicle in response to the actuation of the second switch before an elapse of a predetermined duration from the displacement of the first switch to the depressed position.

16. The method of claim 15, further including determining a speed of the saddle riding vehicle in the forward direction when the first switch is displaced to the depressed position and activating the reversing of the saddle riding utility vehicle in response to the saddle riding utility vehicle being at rest.

17. The method of claim 15, wherein the activates the reversing of the saddle riding utility vehicle when a speed of the saddle riding utility vehicle in the forward direction is below a predefined threshold value when the first switch is displaced to the depressed position.

18. The method of claim 17, wherein the predefined threshold value is 1 miles/hour.

19. The method of claim 15, wherein at the free position of the first switch, the reversing of the saddle riding utility vehicle is inhibited.

20. The method of claim 15 further comprising moving, by the controller, the saddle riding utility vehicle in the reverse direction upon actuation of a throttle lever.
